(19) United States
(12) Patent Application Publication
(10) Pub. No.: US 2006/0079164 A1
(43) Pub. Date: Apr. 13, 2006

(54) Automatic sash safety mechanism

(76) Inventors: Eugene A. DeCastro, Jamestown, NY (US); Ronald Arredondo JR., Jamestown, NY (US)

Correspondence Address: THE BILICKI LAW FIRM, P.C., 1285 North Main Street, Jamestown, NY, 14701, US

(21) Appl. No.: 11/241,327

(22) Filed: Sep. 30, 2005

Related U.S. Application Data
(60) Provisional application No. 60/614,535, filed on Sep. 30, 2004.

(51) Int. Cl. B08B 15/02

(52) U.S. Cl. 454/56

(57) ABSTRACT

A fume hood comprised of: a first and second side wall, a back wall, a work surface, and a top wall, which define a work area; an access opening for providing a user access to the work area; a movable sash member disposed within the fume hood for movement across the access opening to vary the effective size thereof; a drive motor mechanically coupled to the movable sash member; and a pressure-sensitive switch disposed on the bottom surface of the movable sash member. Upon a pressure being exerted on the pressure-sensitive switch in excess of a threshold limit, either by a user pressing against it or by the movable sash member encountering an object left within the access opening, movement of the movable sash member is ceased. The fume hood unit is coupled to an operator sensor to close the sash when the fume hood is not in use.

### CROSS-REFERENCE TO RELATED APPLICATIONS

This application claims the benefit of and priority to U.S. provisional application No. 60/614,535 filed Sep. 30, 2004, incorporated herein in its entirety.

### FIELD OF INVENTION

The present invention relates generally to a mechanical system to automatically open and close a fume hood sash and an accompanying safety feature. Specifically, the present invention relates to a safety mechanism coupled to a drive system for automatically opening and closing a sash of a fume hood to prevent the automatic closure of the fume hood sash if an object is detected in the path of the sash.

### BRIEF DESCRIPTION OF THE DRAWINGS

FIG. 1 is a front view of an exemplary fume hood.

FIG. 2 is a bottom perspective view of the movable sash and access opening to the work space of a fume hood.

FIGS. 3a and 3b show a side view and a front view, respectively, of the operator sensor's range relative to the fume hood.

FIG. 4 shows a close-up bottom perspective view of one embodiment of the movable sash member with one embodiment of a pressure-sensitive switch secured to its lower surface.

FIGS. 5a and 5b show a cross-sectional view of one embodiment of the pressure-sensitive switch taken from circle A of FIG. 4.

FIG. 6 shows one alternate embodiment of the pressure-sensitive switch.

FIG. 7 shows one embodiment of the mechanism by which the pressure-sensitive switch is electrically connected to the drive motor.

FIGS. 8a and 8b show one embodiment of the mechanism by which the electrical cable is secured to the chain.

### DETAILED DESCRIPTION OF EMBODIMENTS OF THE INVENTION

For the purpose of promoting an understanding of the present invention, reference will be made to embodiments of a fume hood as illustrated by the following drawings. It will nevertheless be understood that no limitations to the scope of the invention are thereby intended by such alterations as changing the geometry or any element of the embodiments of the invention or the quantity of each component. It is contemplated that such alterations fall within the spirit and scope of the invention described herein. Some of the possible alterations will be mentioned in the following description. Moreover, it is intended that the invention apply to new fume hoods manufactured with the safety mechanism as to well as retro-fitting existing models.

With particular reference to the drawings, the reader should understand that like numerals in different figures refer to the same elements of the embodiments.

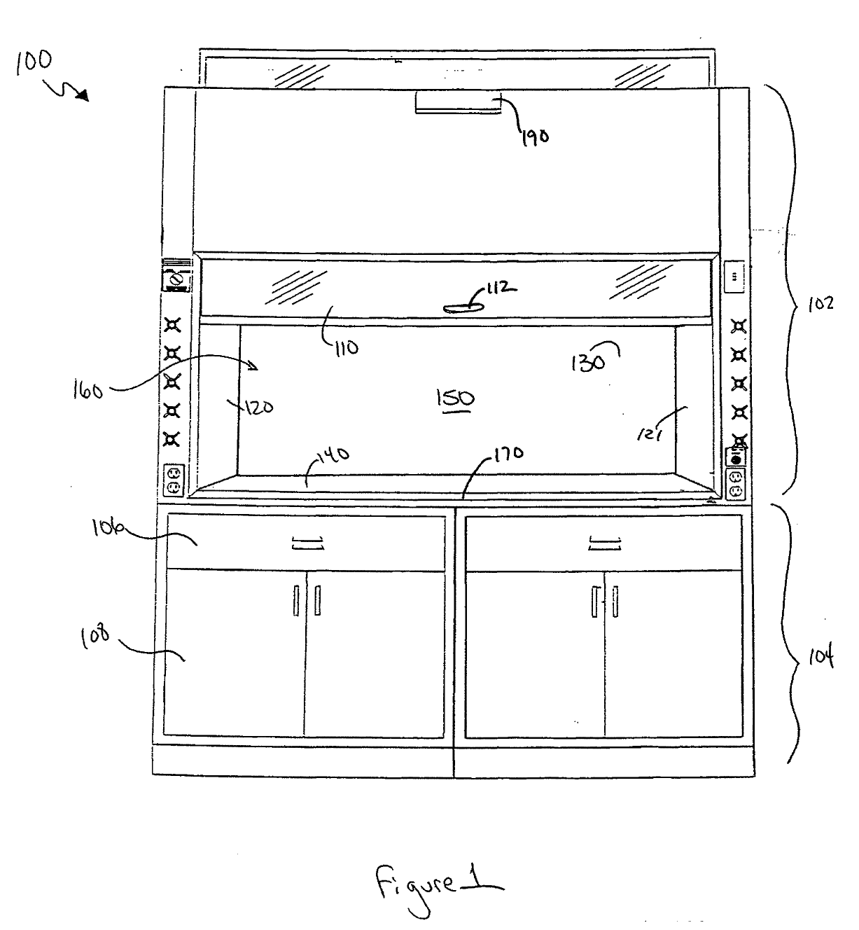

FIG. 1 shows an exemplary fume hood 100. Fume hood 100 is shown with movable sash member 110 in a partially open position. Fume hood 100 is generally comprised of hood portion 102 and base portion 104. Base portion 104 is, in this embodiment, comprised of drawers 106 and cabinets 108. However, this is not intended to be limiting. Rather, any style base portion 104 can be used. A solid pedestal and a base with an opening generally in the middle to provide a user sitting in a chair or wheel chair access to the fume hood are just two alternate examples of base portions 104 that can be combined with hood portion 102. These elements are common to fume hoods and are not intended to limit the invention to any specific type of fume hood, except one in which movable sash member 110 is used.

Visible in FIG. 1 are first and second side walls 120, 121, back wall 130, and work surface 140. They, along with a top wall (not visible) define work area 150. Access opening 160 allows a user to access work area 150 and work surface 140. Movable sash member 110 vertically translates along access opening 160 and provides access to work area 150 and work surface 140 when in the raised or partially raised position (as shown). When in the down position, movable sash member 110 abuts sill 170 and restricts access to work area 150 and work surface 140.

Movable sash member 110 is shown as a single component. However, it should be understood that it is intended that the invention also include embodiments in which the vertically movable sash member 110 further includes horizontally-sliding portions, a collapsing movable sash member, a pair of horizontally telescoping movable sash members, and a walk-in type fume hood in which the sash provides access to a walk-in workspace instead of work surface 140.

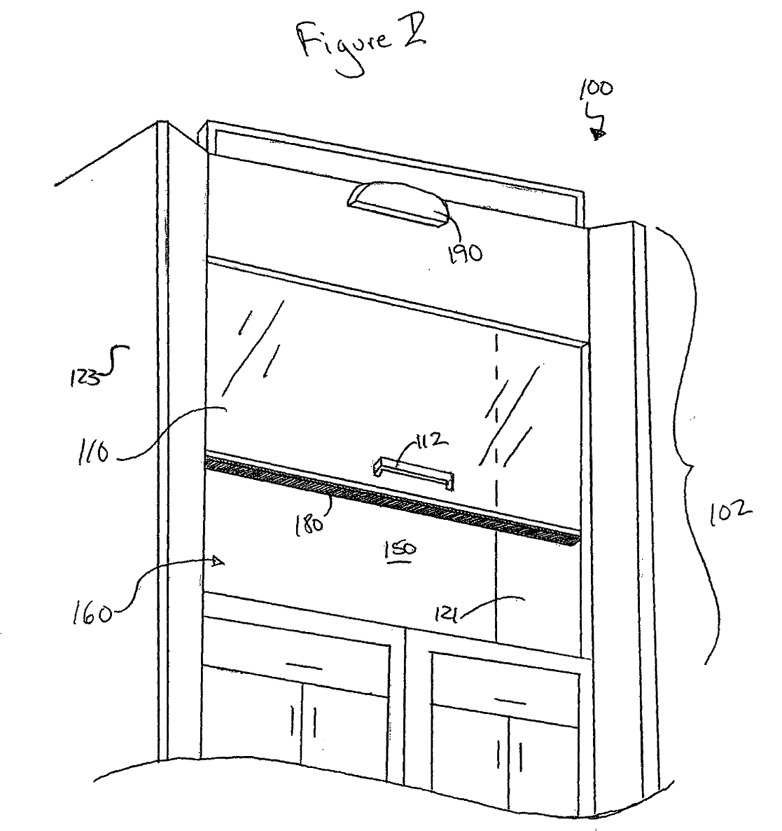

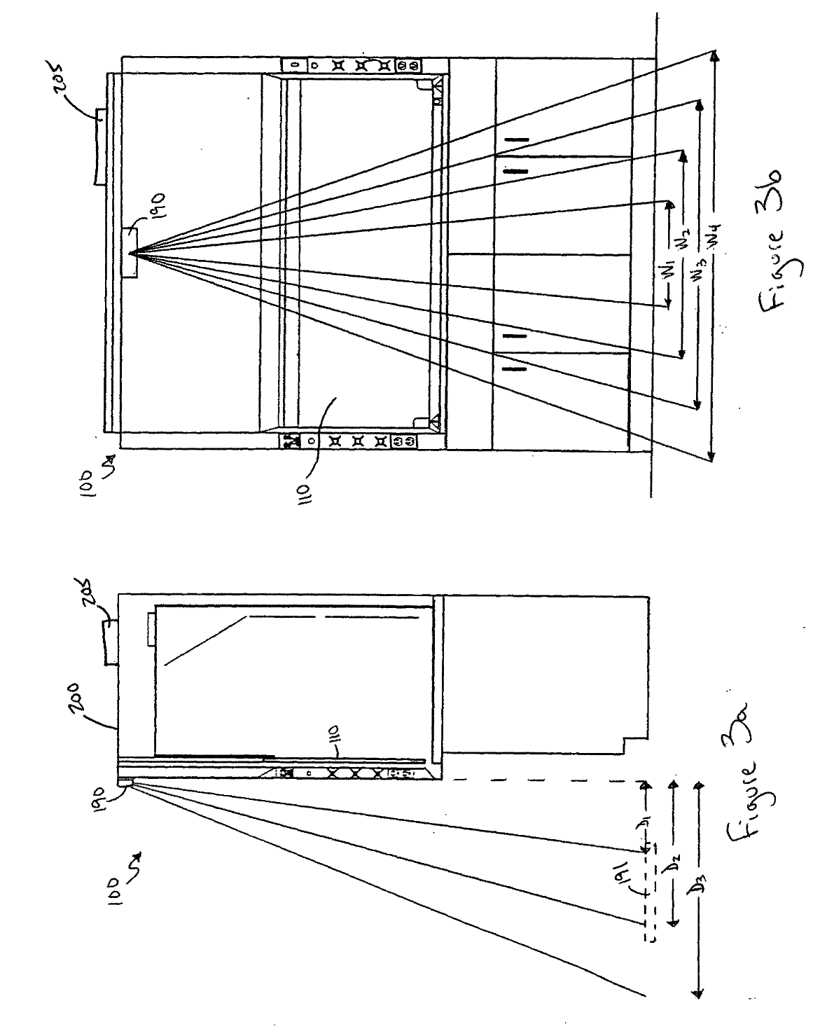

FIG. 2 shows a bottom perspective view of one embodiment of movable sash member 110 and access opening 160 of fume hood 100. From this perspective, access opening 160, work area 150, and second side wall 121 can all also be appreciated. Also visible in FIG. 2 is pressure-sensitive switch 180, secured to the bottom surface of movable sash member 110. Movable sash member 110 is mechanically coupled to an automatic sash positioning system, of any type known in the art. As one example, operator sensor 190 is positioned above where an operator would stand if using fume hood 100, but can be positioned anywhere to detect the presence of an operator. Operator sensor 190 can be an IR (infrared) detector and can also be an RF (radio frequency) motion sensor or any other sensor well-known in the art. In addition, pressure plate 191 can be located in front of fume hood 100 in a position where an operator would generally stand if operating, or preparing to operate, fume hood 100 (as can be seen in FIG. 3a).

FIGS. 3a and 3b show a side view and front view, respectively, of one embodiment of fume hood 100 in which operator sensor 190 can be appreciated. Pressure plate 191 can also be seen in FIG. 3a. In the embodiment shown, operator sensor 190 uses both an IR and RF detector to detect the presence of an operator. One such operator sensor 190 is manufactured by Optex, Inc., model number OA-203C, which can be adjusted to determine the presence of an operator at varying distances in front of fume hood 100 (see distances D₁, D₂, and D₃ in FIG. 3a) and varying widths across the front of fume hood 100 (see W₁, W₂, W₃, and W₄ in FIG. 3b). By adjusting width (W₁, W₂, W₃, and W₄) of the sensor range of operator sensor 190, operator sensor 190 can be used with a fume hood of any width. Furthermore, by using operator sensor 190 capable of varying distances (D₁, D₂, and D₃) in front of fume hood 100, the operator can adjust how close she must come in front of fume hood 100 before sash 110 automatically raises, and reducing the likelihood that movable sash member 110 will be inadvertently raised by a passerby not operating fume hood 100, i.e., a false detection (discussed in greater detail infra). Alternate embodiments of the invention can include a less sophisticated operator sensor 190 or multiple operator sensors 190, alone or in combination with, for example, pressure plate 191.

When operator sensor 190 detects the presence of an operator, movable sash member 110 is automatically raised to allow the operator access to work area 150 using an automatic sash positioning mechanism (discussed in greater detail infra). As long as the operator is in a position in which she can be detected by operator sensor 190, movable sash member 110 will remain in the up position. Movable sash member 110 can also be moved manually using handle 112 in the event that the operator wishes to manually change the position of movable sash member 110 while using fume hood 100 (see FIGS. 1 and 2).

Fume hood 100 can further be comprised of an exhaust system (shown as exhaust port 205 on top surface 200). When movable sash member 110 is in the raised position, exhaust flow is increased and when in the lowered position, the exhaust flow is decreased to conserve energy. This is known as a variable air volume (VAV) damper system. The position of movable sash member 110 is coupled to the VAV system so that when fume hood 100 is not in use, movable sash member 110 is lowered and the exhaust flow is reduced to reduce energy consumption. That is, the exhaust blower is coupled to the position of movable sash member 110 so that it is operated at high speed when movable sash member 110 is in a raised position and at a lower speed when movable sash member 110 is in a closed or lowered position.

When the operator leaves fume hood 100, the automatic sash positioning mechanism lowers movable sash member 110 so that the bottom surface abuts the sill (visible in FIG. 1). The lowering can be set at any time delay after an operator is not detected. For example, in one embodiment, if an operator is not detected by operator sensor 190 for ten (10) seconds, movable sash member 110 will be lowered. In the embodiment in which operator sensor 190 is model number OA-203C manufactured by Optex, Inc., as described supra, the interval can be set to a shorter period of time (e.g. two to three seconds) because of the increased sensitivity and accuracy due to the use of both IR and RF detection.

However, despite an operator leaving fume hood 100, an object can be left within opening 160, i.e., immediately below movable sash member 110, such that if movable sash member 110 were to automatically lower to the completely closed position, the object left within opening 160 or fume hood 100 itself can be damaged. To prevent damage, movable sash member 110 has pressure-sensitive switch 180 (described in detail infra) secured to the bottom surface of movable sash member 110 and running the entire length of its bottom surface. In the event that, as it is being automatically lowered, movable sash member 110 encounters an object that resists movement of movable sash member 110 (either an object or the operator herself), the downward descent of movable sash member 110 is immediately halted.

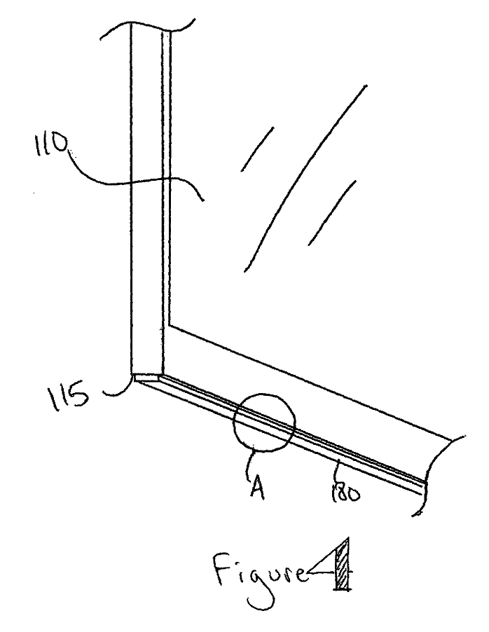

FIG. 4 shows a bottom perspective close-up view of one embodiment of movable sash member 110, with pressure-sensitive switch 180 secured to lower surface 115 of movable sash member 110. As previously desctibed, if movable sash member 110 encounters an object as it is lowered, due to the presence of pressure-sensitive switch 180, the movement of movable sash member 110 is halted. Pressure-sensitive switch 180 can also be used by an operator to manually halt the descent of movable sash member 110 by pressing against pressure-sensitive tape 180.

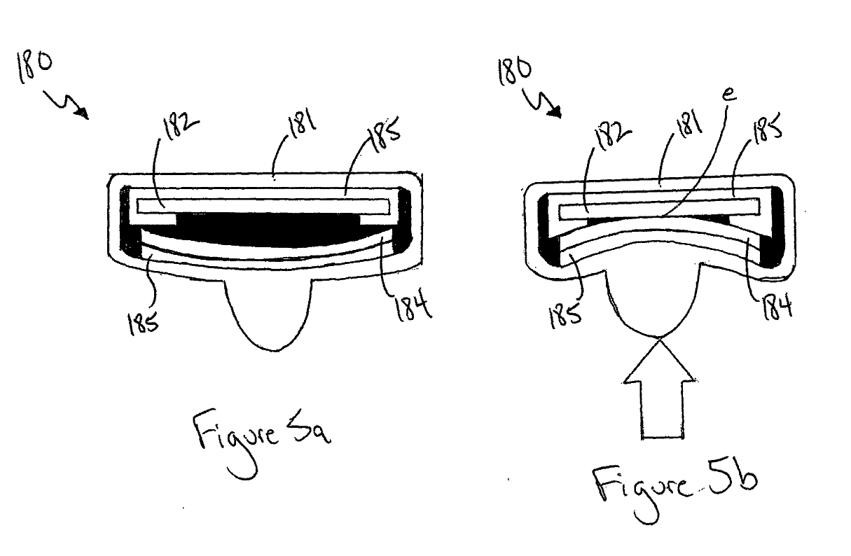

FIGS. 5a and 5b show a cross-sectional views of one embodiment of pressure-sensitive switch 180 taken from circle A of FIG. 4 and the principle of operation. Pressure-sensitive switch 180 includes a series of upper electrode plates 182 and corresponding lower electrode plates 184 within cover 181 (just one of each is visible in cross-section). Each pair extends the width of pressure-sensitive switch 180 and there are pairs along the entire length of pressure-sensitive switch 180. Both upper electrode plate 182 and lower electrode plate 184 are partially encased within insulating material 185 to prevent contact between upper electrode plate 182 and lower electrode plate 184 when not under load, as seen in FIG. 5a. As seen in FIG. 5b, when pressure-sensitive switch 180 is under load (see arrow), i.e., when in contact with an object in the path of the movable sash member (not shown), upper electrode plate 182 and lower electrode plate 184 come in contact with one another at point e, completing an electrical circuit. Pressure-sensitive switch 180 is electrically connected to the drive motor (not shown). By using a circuit with reverse logic, power to the drive motor is shut off when the electrical circuit is completed within pressure-sensitive switch 180 and power to the drive motor is enabled when upper electrode plate 182 and lower electrode plate 184 are not in contact with one another.

One example of pressure-sensitive switch 180 is model LS-023 as manufactured by Tokyo Sensor Co., Ltd., which can be sized to fit any length of movable sash member 110. This particular model provides pressure-sensitive switch 180 with a low profile to increase the Coanda effects of air being drawn into the fume hood (not shown) along pressure-sensitive switch 180. This particular model of pressure-sensitive switch 180 is configured to operate such that upper electrode plate 182 and lower electrode plate 184 come in contact with one another at approximately 2.3 Newtons of force (i.e., approximately one quarter pound of force). Pressure-sensitive switch 180 is secured to bottom surface 115 of movable sash member (see FIG. 4) via any sufficiently strong glue, adhesive, tape, or other securing mechanism. In one embodiment, 3M tape, part number 4929 is used, but is not intended to be limiting.

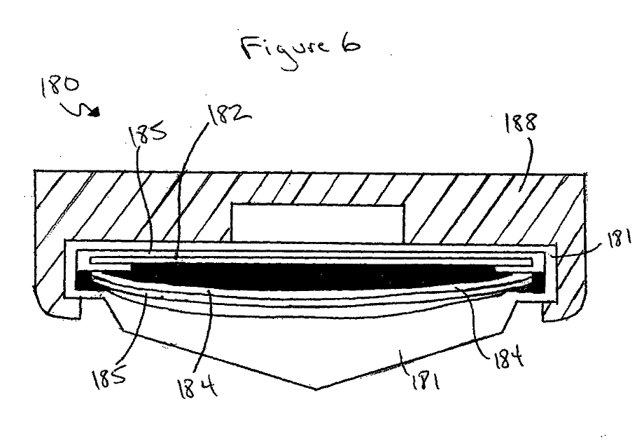

Other pressure-sensitive switches 180 can be used as well. FIG. 6 shown an alternate embodiment of pressure-sensitive switch 180, model number LB-060, also from Tokyo Sensor, in which pressure-sensitive switch 180 is set into fitting channel 188 and fitting channel 188 is secured to the bottom surface of the movable sash member (not shown). This particular model of pressure-sensitive switch 180 is set with an operating load of 6 Newtons (approximately two thirds of a pound of force). However, one of ordinary skill in the art will realize that pressure-sensitive switch 180 with any load value that will stop the movement of movable sash member 110 can be used, depending on the needs of the operator.

Pressure-sensitive switch 180 of FIG. 6 also has an alternately-shaped and a larger profile due to the thickness of fitting channel 188. Using fitting channel 188 allows an alternate method of securing pressure-sensitive switch 180 to the bottom surface of the movable sash member. Fitting channel 188 can be secured to the bottom surface of the movable sash member via screws, rivets, adhesive tape, glue, bands, or any other method or mechanism known to those of ordinary skill in the art. Another advantage of using fitting channel 188 is that although fitting channel 188 may be permanently secured to the fume hood (not shown), pressure-sensitive switch 180 need not be permanently secure within fitting channel 188, allowing pressure-sensitive switch 181 to be exchanged for another with a different operating load.

In an alternate embodiment, there is a delay between when operator sensor 190 detects an operator and when movable sash member 110 is opened, e.g., five (5) seconds. This prevents movable sash member 110 from raising when a person only passes near fume hood 100, as stated supra. Handle 112 permits an operator to manually raise and lower movable sash member 110. In an alternate embodiment, rails are provided, in front of fume hood 100 to prevent passing personnel from triggering operator sensor 190 without the intention of using fume hood 100. This delay also allows the VAV damper system to spool up to a proper speed corresponding to the appropriate static pressure for movable sash member 110 in the up position.

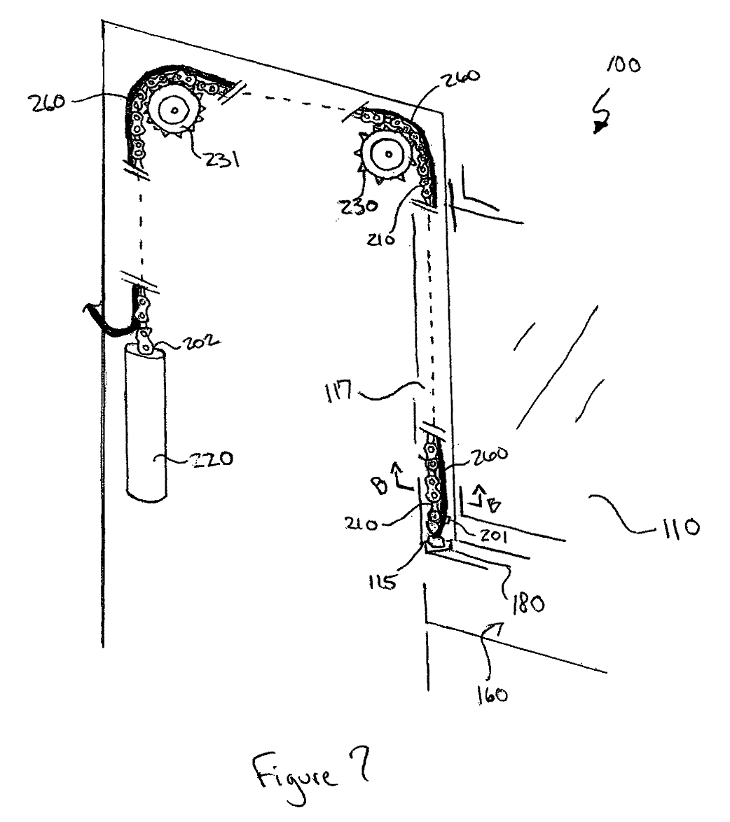

FIG. 7 shows one embodiment of the mechanism by which pressure-sensitive switch 180 is electrically connected to the drive motor (not shown) via a partial bottom perspective view of fume hood 100. In this embodiment, pressure-sensitive switch 180 is electrically connected to the drive motor via electrical cable 260, and pressure-sensitive switch 180, disposed on bottom surface 115 of movable sash member 110, as discussed supra, can all be appreciated. In the embodiment shown in FIG. 7, chain 210 is secured on one end to side surface 117 of movable sash member 110 at point 201 and at a second end to counterweight 220 at point 202. Chain 210 mechanically engages sprockets 230 and 231, and sprocket 231 is driven by the drive motor. This system enables the drive motor to raise and lower movable sash member 110 without having to lift the weight of movable sash member 110 and is well-known in the art. This is not, however, intended to be limiting. Fume hood 100 could be constructed with chain 210 connected to movable sash member 110 at another point, with chain 210 being replaced by a belt or cable and sprockets 230 and 231 being replaced by a urethane-coated wheel, using pulleys, additional or fewer sprockets, different orientations of sprockets 230 and 231, or any other combination known by those of ordinary skill in the art.

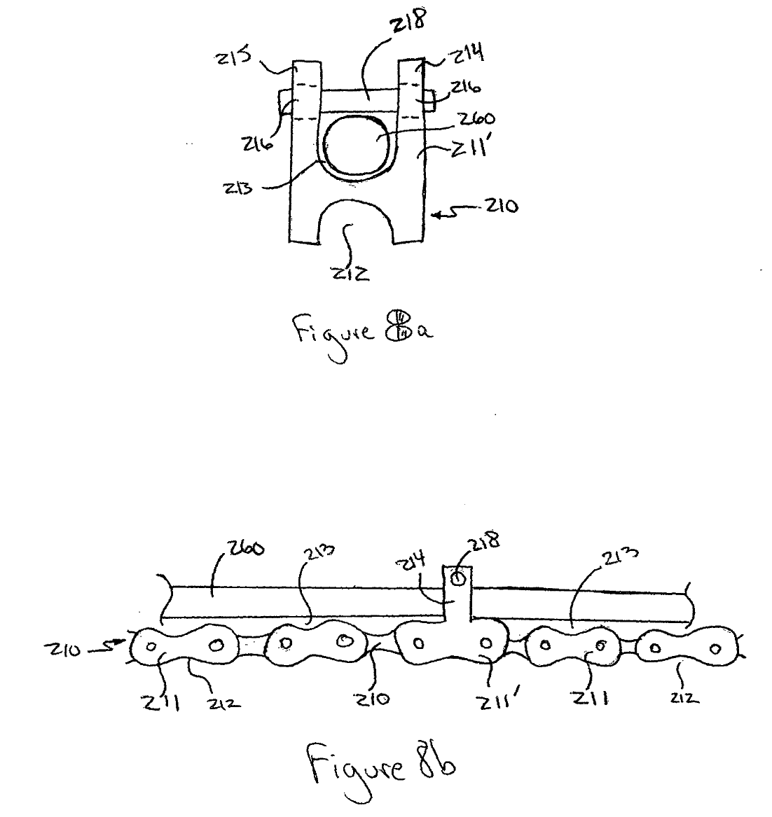

In one embodiment, electrical cable 260 is secured to the top of chain 210, as shown in FIGS. 8a and 8b. FIG. 8a shows one securing link 211′ in chain 210 and electrical cable 260 attached thereto from a perspective taken along B-B of FIG. 7. As can be seen, securing link 211′ of chain 210 has first recess 212, adapted to engage the sprocket (not shown) and second recess 213 adapted to receive electrical cable 260. Extending from link 211 are bands 214 and 215, each of which include hole 216 therethrough (shown in dashed lines) to accommodate securing member 218. Securing member 218 secures electrical cable 260 to the back of chain 210.

Electrical cable 260 is then electrically connected on a first end to pressure-sensitive switch 180 and on a second end to the drive motor, which is generally on top of fume hood 100. Upon an operating load being exerted against pressure-sensitive switch 180 in excess of the threshold limit, an electrical signal is sent to the drive motor, which is then stopped, stopping the movement of movable sash member 110.

FIG. 8b shows a side view of chain 210, comprised of links 211 and securing link 211′. Links 211 also have first recess 212 for engaging the sprockets (not shown) and second recess 213 for receiving electrical cable 260. However, as can be seen, securing link 211′ further includes band 214 for securing electrical cable 260 to the back of chain 210. Any number of securing links 211′ can be used so long as electrical cable 260 is secured to chain 210 and does not separate from chain 210 such that it could get caught by the sprocket. Only a portion of chain 210 is shown, and the number of securing links 211′ will depend on the operational requirements of the fume hood as well as the choice of chain 210 and electrical cable 260.

In this embodiment, electrical cable 260 is designed for continuous flex service and selected to be both sufficiently durable and flexible as well as bend along with chain 210 as it passes over the sprocket(s). Electrical cable from Alpha Wire and Cable Coil, model number 85003, a flexible three-conductor conduit cable with a twenty gauge is used in the embodiment shown. In an alternate embodiment, electrical cable from Manhattan Cable, model number F-120910 can be used.

While several embodiments of the present invention have been shown and described, it is to be understood that the invention is not limited thereto, but is susceptible to numerous changes and modifications as known to a person skilled in the art, and it is intended that the present invention not be limited to the details shown and described herein, but rather cover all such changes and modifications as are obvious to one of ordinary skill in the art.

What is claimed is:

1. A device comprised of:
a first side wall;
a second side wall;
a back wall;
a work surface;
a top wall, said first side wall, said second side wall, said back wall, said work surface, and said top wall defining a work area;
an access opening for providing a user access to said work area;
a movable sash member, said movable sash member comprised of a bottom surface and disposed for vertical movement across said access opening to vary an effective size thereof;
a drive motor electrically connected to said movable sash member;
an operator sensor, said operator sensor electrically coupled to said drive motor for automatically raising said movable sash member when an operator is detected and automatically lowering said movable sash member when an operator is not detected; and
a pressure-sensitive switch disposed on said bottom surface of said movable sash member and electrically connected to said drive motor, wherein upon a pressure being exerted on said pressure-sensitive switch in excess of a threshold limit, said drive motor is stopped and movement of said movable sash member is halted.

2. The device of claim 1, wherein said device is selected from a group comprised of a fume hood and a walk-in type fume hood.

3. The device of claim 1, wherein said device is further comprised of a variable air volume damper system to reduce energy consumption when said movable sash member is in a closed position.

4. The device of claim 1, wherein said movable sash member is comprised of components selected from a group comprised of at least one horizontally-sliding portion, a collapsing movable sash member, at least one horizontally telescoping movable sash member, and combinations thereof.

5. The device of claim 1, wherein said operator sensor is selected from a group comprised of an infrared detector, a radio frequency motion sensor, a pressure plate generally in front of said device, and combinations thereof.

6. The device of claim 1, wherein said threshold limit of said pressure exerted on said pressure-sensitive switch to halt movement of said movable sash member is 0.25 pounds of force.

7. The device of claim 1, wherein said drive motor is mechanically coupled to said movable sash member with a chain and mechanically coupled to at least one sprocket, and wherein said pressure-sensitive switch is electrically connected to said drive motor with an electrical cable secured to a back side of said at least one chain.

8. The device of claim 1, wherein said pressure-sensitive switch is comprised of a series of upper electrode plates and a series of corresponding lower electrode plates, both of said series substantially encased within an insulating material, wherein when under load, at least one of said series of upper electrode plates comes in contact with at least one of said series of lower electrode plates to stop said drive motor and halt movement of said movable sash member.

9. The device of claim 1, wherein said drive motor is mechanically coupled to said movable sash member with a belt secured to said movable sash member on a first end of said belt and at least one wheel and said pressure-sensitive switch is electrically connected to said drive motor with an electrical cable secured to a back side of said belt.

10. The device of claim 1, wherein said device is further comprised of a fitting channel secured to said bottom surface of said movable sash member, wherein said pressure-sensitive switch is disposed within said fitting channel.

11. A fume hood comprised of:
a first side wall and a second side wall, a back wall, a work surface, and a top wall, said first side wall and said second side wall, said back wall, said work surface, and said top wall defining a work area;
an access opening for providing a user access to said work area;
a movable sash member, said movable sash member comprised of a bottom surface and disposed for vertical movement across said access opening to vary an effective size thereof;
a drive motor mechanically coupled to said movable sash member, wherein said drive motor is mechanically coupled to said movable sash member to a chain on a first end of said chain and to a counterweight on a second end of said chain;
an operator sensor, said operator sensor electrically coupled to said movable sash member for automatically raising said movable sash member when an operator is detected and automatically lowering said movable sash member when an operator is not detected for a specified period of time; and
a pressure-sensitive switch disposed on said bottom surface of said movable sash member and electrically connected to said drive motor via an electrical cable secured to a back side of said chain, wherein upon a pressure being exerted on said pressure-sensitive switch in excess of a threshold limit, said movable sash member is stopped.

12. The fume hood of claim 11, wherein said fume hood is selected from a group comprised of a fume hood and a walk-in type fume hood.

13. The fume hood of claim 11, wherein said fume hood is further comprised of a variable air volume damper system to reduce energy consumption of said fume hood when said movable sash member is in a closed position.

14. The fume hood of claim 11, wherein said movable sash member is comprised of components selected from a group comprised of at least one horizontally-sliding portion, a collapsing movable sash member, at least one horizontally telescoping movable sash member, and combinations thereof.

15. The fume hood of claim 11, wherein said operator sensor is selected from a group comprised of an infrared detector, a radio frequency motion sensor, a pressure plate substantially in front of said fume hood, and combinations thereof.

16. The fume hood of claim 11, wherein said pressure-sensitive switch is comprised of a series of upper electrode plates and a series of corresponding lower electrode plates, both of said series substantially encased within an insulating material, wherein when under load, at least one of said series of upper electrode plates comes in contact with at least one of said series of lower electrode plates to stop said drive motor and halt movement of said movable sash member.

17. The fume hood of claim 11, wherein said threshold limit of said pressure exerted on said pressure-sensitive switch to halt movement of said movable sash member is 0.25 pounds of force.

18. The fume hood of claim 11, wherein said fume hood is further comprised of a fitting channel secured to said bottom surface of said movable sash member, wherein said pressure-sensitive switch is disposed within said fitting channel.

19. An apparatus comprised of:
a hood portion comprised of:
a first side wall;
a second side wall;
a back wall;
a work surface;
a top wall, said first side wall, said second side wall, said back wall, said work surface, and said top wall defining a work area;
an access opening for providing a user access to said work area;
a movable sash member, said movable sash member comprised of a bottom surface and disposed for vertical movement across said access opening to vary an effective size thereof;
a drive motor mechanically coupled to said movable sash member;
an operator sensor, said operator sensor electrically coupled to said movable sash member for automatically raising said movable sash member when an operator is detected and automatically lowering said movable sash member when an operator is not detected; and
a pressure-sensitive switch disposed on said bottom surface of said movable sash member and electrically connected to said drive motor, said pressure-sensitive switch comprised of a series of upper electrode plates and a series of corresponding lower electrode plates, both of said series substantially encased within an insulating material, wherein upon a pressure being exerted on said pressure-sensitive switch in excess of a threshold limit, at least one of said series of upper electrode plates comes in contact with at least one of said series of lower electrode plates to stop said drive motor and halt movement of said movable sash member; and
a base portion for supporting said hood portion.

20. The apparatus of claim 19, wherein said apparatus is selected from a group comprised of a fume hood and a walk-in type fume hood.

21. The apparatus of claim 19, wherein said apparatus is further comprised of a variable air volume damper system to reduce energy consumption when said movable sash member is in a closed position.

22. The apparatus of claim 19, wherein said movable sash member is comprised of components selected from a group comprised of at least one horizontally-sliding portion, a collapsing movable sash member, at least one horizontally telescoping movable sash member, and combinations thereof.

23. The apparatus of claim 19, wherein said operator sensor is selected from a group comprised of an infrared detector, a radio frequency motion sensor, a pressure plate immediately in front of said device, and combinations thereof.

24. The apparatus of claim 19, wherein said threshold limit of said pressure exerted on said pressure-sensitive switch to halt movement of said movable sash member is 0.25 pounds of force.

25. The apparatus of claim 19, wherein said drive motor is mechanically coupled to said movable sash member via a chain and mechanically coupled to at least one sprocket, and wherein said pressure-sensitive switch is electrically connected to said drive motor via an electrical cable secured to a back side of said at least one chain.

26. The apparatus of claim 19, wherein said drive motor is mechanically coupled to said movable sash member via a belt secured to said movable sash member on a first end of said belt and at least one wheel and said pressure-sensitive switch is electrically connected to said drive motor via an electrical cable secured to a back side of said belt.

27. The apparatus of claim 19, wherein said apparatus is further comprised of a fitting channel secured to said bottom surface of said movable sash member, wherein said pressure-sensitive switch is disposed within said fitting channel.

28. A method of controlling a position of a movable sash member within a fume hood unit comprising the steps of:
mechanically coupling a drive motor to said movable sash member;
securing a pressure-sensitive switch to a bottom surface of said movable sash member;
detecting the absence of a user by an operator sensor;
said drive motor lowering said movable sash member in response to said detecting step after a predetermined time period; and
electrically connecting said pressure-sensitive switch to said drive motor such that when said pressure-sensitive switch contacts an object in excess of a threshold limit, said pressure-sensitive switch sends an electric signal to said drive motor and said lowering step is stopped.

29. The method of claim 28, wherein said fume hood is further comprised of a variable air volume damper system to reduce energy consumption when said movable sash member is in a closed position.

30. The method of claim 28, wherein said movable sash member is comprised of components selected from a group comprised of at least one horizontally-sliding portion, a collapsing movable sash member, at least one horizontally telescoping movable sash member, and combinations thereof.

31. The method of claim 28, wherein said operator sensor is selected from a group comprised of an infrared detector, a radio frequency motion sensor, a pressure plate immediately in front of said device, and combinations thereof.

32. The method of claim 28, wherein said drive motor is mechanically coupled to said movable sash member via a chain and mechanically coupled to at least one sprocket, and wherein said pressure-sensitive switch is electrically connected to said drive motor via an electrical cable secured to a back side of said at least one chain.

33. The method of claim 28, wherein said drive motor is mechanically coupled to said movable sash member via a belt secured to said movable sash member on a first end of said belt and at least one wheel and said pressure-sensitive switch is electrically connected to said drive motor via an electrical cable secured to a back side of said belt.

34. The method of claim 28, wherein said pressure-sensitive switch is comprised of a series of upper electrode plates and a series of corresponding lower electrode plates, both of said series substantially encased within an insulating material, wherein when under load, at least one of said series of upper electrode plates comes in contact with at least one of said series of lower electrode plates to stop said drive motor and halt movement of said movable sash member.

35. The method of claim 28, wherein said threshold limit of said pressure-sensitive switch to halt said lowering step is 0.25 pounds of force.

36. The method of claim 28, wherein said fume hood is further comprised of a fitting channel secured to said bottom surface of said movable sash member, wherein said pressure-sensitive switch is disposed within said fitting channel.
